(19) United States
(12) Patent Application Publication
(10) Pub. No.: US 2009/0174732 A1
(43) Pub. Date: Jul. 9, 2009

(54) IMAGE DISPLAY CONTROLLING METHOD AND APPARATUS OF MOBILE TERMINAL

(75) Inventors: Young-woo Lee, Suwon-si (KR); Tae-kyun Kim, Suwon-si (KR); Sung-bin Kuk, Wonju-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/211,303

(22) Filed: Sep. 16, 2008

(30) Foreign Application Priority Data
Jan. 8, 2008 (KR) 2008-2309

(51) Int. Cl. G09G 5/02

(52) U.S. Cl. 345/698

(57) ABSTRACT

An image display controlling apparatus and method, which can automatically divide an image signal according to the size of a screen in a mobile terminal. The image display controlling method includes generating frames having inner and outer edges based on an image signal; measuring a ratio of the size of each generated frame to the size of a display area; adjusting a number of frames to be displayed on the display area according to the measured ratio; and displaying a frame image corresponding to the adjusted number of frames on the display area.

### CROSS-REFERENCE TO RELATED APPLICATIONS

This application claims the benefit of Korean Patent Application No. 2008-2309, filed in the Korean Intellectual Property Office on Jan. 8, 2008, the disclosure of which is incorporated herein by reference.

### BACKGROUND OF THE INVENTION

1. Field of the Invention

Aspects of the present invention relate to an image displaying apparatus, such as a mobile terminal or an image viewer, and more particularly, to an image display controlling apparatus and method that automatically divides an image signal according to a screen size.

2. Description of the Related Art

With the development of wireless communication technologies and internet technologies, it is possible for content, such as music, books, and comics, to be transmitted to a mobile terminal, such as a personal digital assistant (PDA) or an image viewer. Accordingly, a user can enjoy the content received to his/her mobile terminal by viewing and listening to the content.

However, the screen size of the mobile terminal, is small, and thus the size of the image displayed to the user is small. For example, in order to view a comic image with letters scattered throughout the comic image in a conventional mobile terminal, the comic image should be reduced as shown in FIG. 1A. However, in such conventional full view mode, the letters cannot be read easily, and the eyes of the user are easily fatigued. Alternatively, the comic image can be enlarged and then viewed by scrolling the image, as shown in FIG. 1B. However, in such enlarge/scroll view mode, the user is inconvenienced, and may not view the comic image due to annoyance.

### SUMMARY OF THE INVENTION

Aspects of the present invention provide an image display controlling method and apparatus, which can reduce visual distortion by automatically adjusting the number of frames to be displayed according to a screen size.

Additional aspects of the present invention provide a mobile terminal using the image display controlling method and apparatus.

According to an aspect of the present invention, an image display controlling method is provided. The method includes generating frames having inner and outer edges based on an image signal; measuring a ratio of the size of each generated frame to the size of a display area; adjusting a number of frames to be displayed on the display area according to the measured ratio; and displaying a frame image corresponding to the adjusted number of frames on the display area.

According to another aspect of the present invention, an image display controlling apparatus is provided. The apparatus includes a frame generator to form frames having an outer non-linear section of an outer edge interpolated by a linear component from image data, and to detect internal horizontal/vertical outlines by checking columns and rows of the frames; and a display area determiner to adjust the number of frames to be displayed on a display area according to a ratio of the size of each frame generated by the frame generator to the size of the display area.

According to another aspect of the present invention, a mobile terminal is provided. The mobile terminal includes a storage unit, which stores image data; a display, which displays an image in a frame unit; and an image signal processor, which generates frames having inner and outer edges in regards to the image data stored in the storage unit, adjusts the number of frames to be displayed on a display area according to a ratio of the size of each frame to the size of the display area, and displaying the corresponding frames on the display.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are screens of a mobile terminal using a conventional image displaying method;

FIG. 2 illustrates an image display controlling apparatus of a mobile terminal, according to an embodiment of the present invention;

FIG. 3 illustrates in detail the image signal processor illustrated in FIG. 2;

FIG. 4 is a flowchart of an image display controlling process of a mobile terminal, according to an embodiment of the present invention;

FIGS. 5A through 5C illustrate embodiments of forming frames from an image;

FIG. 6 is a flowchart of a process of adjusting the number of frames be merged in a display area, according to an embodiment of the present invention;

FIG. 7 illustrates an embodiment of displaying a merged frame generated according to the method of FIG. 6; and

FIG. 8 is a flowchart of a process of adjusting the number of frames to be merged in a display area, according to another embodiment of the present invention.

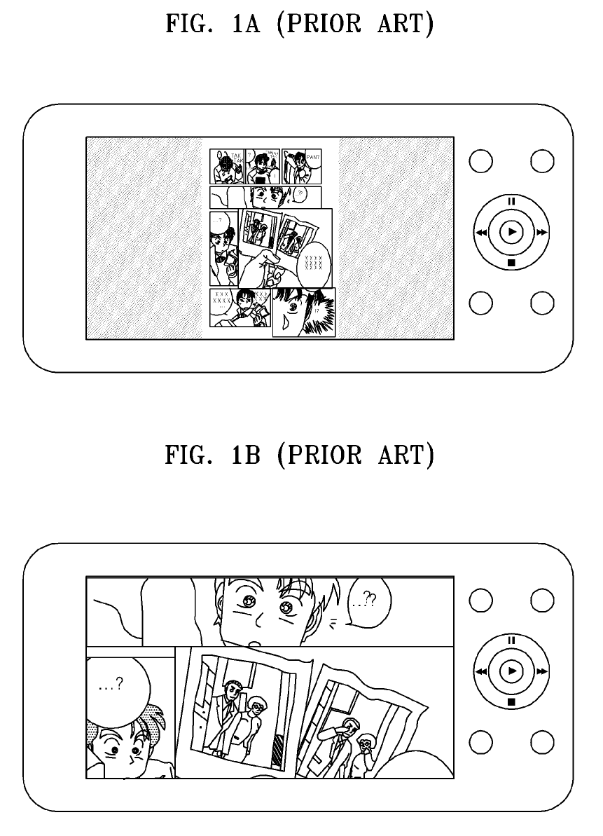

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 shows an image display controlling apparatus of a mobile terminal, according to an embodiment of the present invention. The image display controlling apparatus includes a key input unit 210, an image signal processor 220, a storage unit 230, and a display 240. According to other aspects of the present invention, the image display controlling apparatus may include additional and/or different units. Similarly, the functionality of two or more of the above units may be integrated into a single component.

The key input unit 210 inputs a user command through a plurality of key modules or a touch screen. For example, the key input unit 210 transmits a focusing mark control command to the image signal processor 220 using a certain pre-established key. The storage unit 230 may be, for example, a flash memory or a hard disk drive, and stores content and a control program that operates the image signal processor 220.

The display 240 displays an image outputted from the image signal processor 220 in a frame unit, and also displays command information requested by a user. The image signal processor 220 generates frames having inner and outer edges with regards to an image stored in the storage unit 230, measures a ratio of the size of each generated frame to the size of a display area, adjusts the number of frames to be displayed on the display area according to the measured size, and displays the corresponding frames on the display 240.

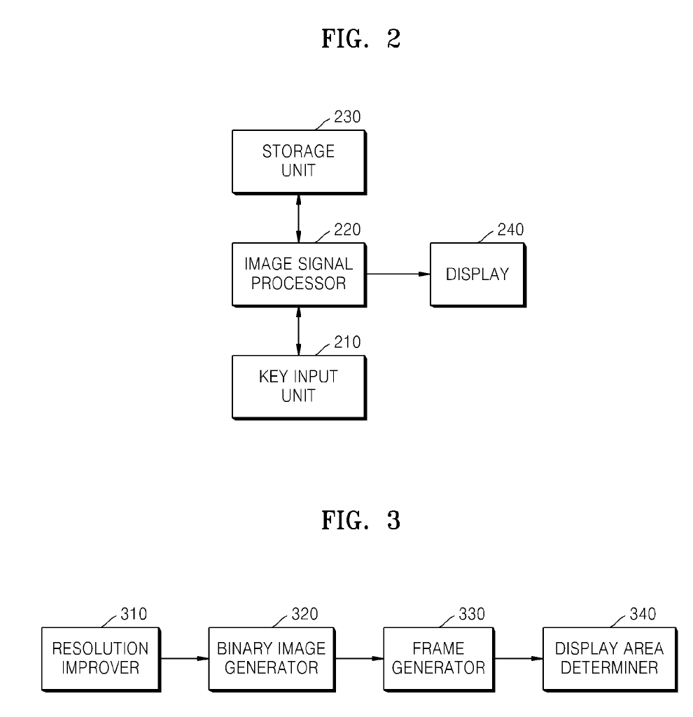

FIG. 3 shows the image signal processor 220 in more detail. The image signal processor 220 includes a resolution improver 310, a binary image generator 320, a frame generator 330, and a display area determiner 340.

The resolution improver 310 emphasizes the resolution of edges by applying an edge detection mask on a received image signal. The binary image generator 320 converts the image signal to a binarized image. The frame generator 330 extracts an outer edge of the binarized image, interpolates a non-linear section of the outer edge with a linear component so as to form frames, and detects internal horizontal/vertical outlines by checking columns and rows of the frames. The display area determiner 340 measures a ratio of the size of each frame generated by the frame generator 330 to the size of a display area, automatically adjusts the number of frames to be displayed on the display area according to the ratio, and displays the corresponding frame on the display area.

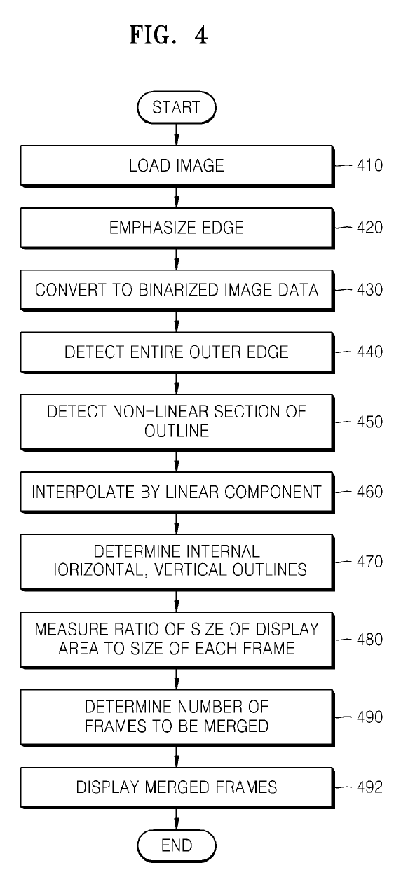

FIG. 4 is a flowchart of an image display controlling process of a mobile terminal, according to an embodiment of the present invention. An image that is internally stored or received via a network is loaded in operation 410. Due to a story development condition, a comic image may not include a frame, and a horizontal and vertical frame may not be distinct.

The resolution of an edge of the image is emphasized by using an edge detection mask in operation 420. For example, an inputted image is changed to a gray scale, and then a section having a large brightness difference is emphasized. The image with the emphasized edge is converted to binarized image data in operation 430. For example, a gray value of each pixel of the image with emphasized edge is compared with a threshold. If the gray value is bigger than the threshold, the corresponding pixel is set to 1. If the gray value is smaller than the threshold, the corresponding pixel is set to 0.

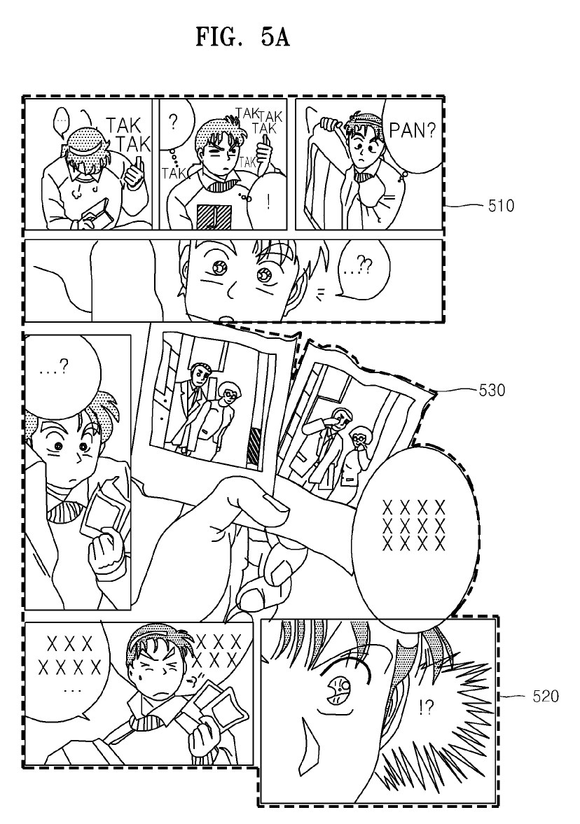

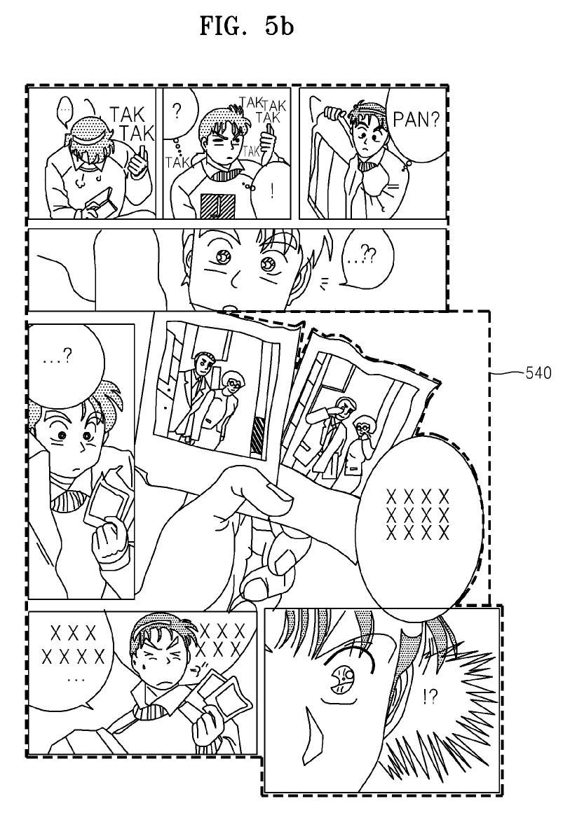

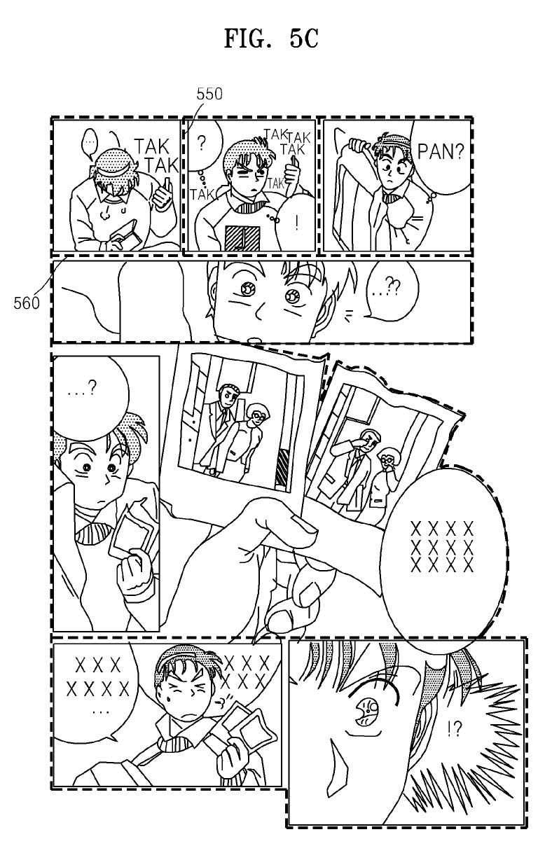

In operation 440, the entire outer edge is detected from the binarized image data. Referring to FIG. 5A, the most outer edge of image data corresponds to white, and thus is 0. Then, when the edge starts, 0 and 1 are repeated in the image data. A section 510 where 0 is repeated and then 1 starts is detected as an outer edge of the image data. A section 520 where 0 and 1 are repeated from the beginning is regarded as a section without an empty space, and thus detected as an outer edge of the image data.

If frames of the image are not clearly divided, the outer edge is not linear, but may be non-linear according to the content, such as a section 530. Accordingly in operation 450 of FIG. 4, a non-linear section of the outline is detected from the entire outer edge. For example, a coordinate of the non-linear section is detected by checking linearity of rows and columns of the entire outer edge.

In operation 460, the non-linear section is interpolated by a predetermined linear component. For example, the non-linear section may be interpolated by the predetermined linear component based on the coordinate of the outermost line from among the non-linear section. As shown in a section 540 of FIG. 5B, the interpolation is performed from a non-linear section of the outer edge to a linear section of the outer edge. As a result, the image data is formed into a frame.

In operation 470, internal horizontal and vertical outlines are determined by checking rows and columns based on the coordinates of the interpolated outer edge. For example, as shown in a section 560 of FIG. 5C, a row having linear data from the left end to the right end, determined by checking rows of the edge of the generated frame, may be determined as the internal horizontal outline. In addition, as shown in a section 550 of FIG. 5C, a column having linear data from the top end to the bottom end, determined by checking columns of each determined internal horizontal outline, may be determined as the internal vertical outline.

In operation 480 of FIG. 4, a ratio of the size of a display area to the size of each frame is measured. The size of a frame may vary according to the content of a comic, but the size of the display area is fixed. The size of the frame may be measured using the coordinates of the outline.

The number of frames to be merged in the display area is adjusted in operation 490 according to a threshold established for measured ratio and a distortion margin. For example, the number of frames to be merged may be automatically determined by comparing the ratio with the threshold. The ratio may be obtained by dividing the size of a frame by the size of the display area. The threshold may be obtained by adding the distortion margin and a ratio of the size of a currently used display area to the size of an ideal display area. The merged frame is displayed on the display area in operation 492.

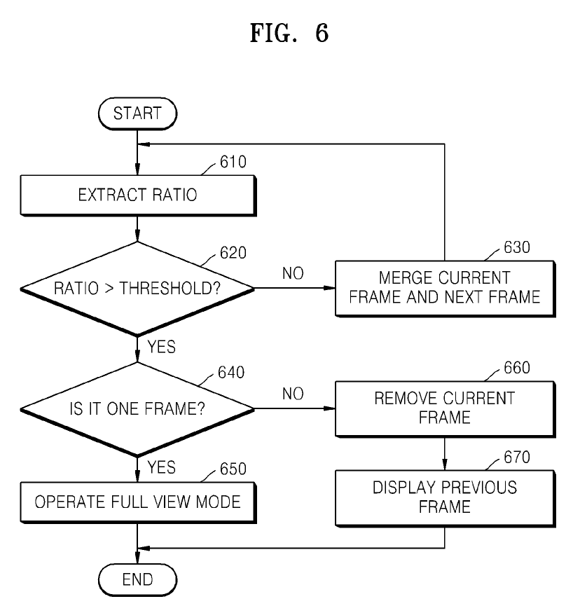

FIG. 6 is a flowchart of a process of adjusting the number of frames to be merged in a display area, according to an embodiment of the present invention. A ratio of the size of a display area to a size of each frame is determined in operation 610. The ratio of the size of the frame to the size of the display area is compared with a threshold in operation 620.

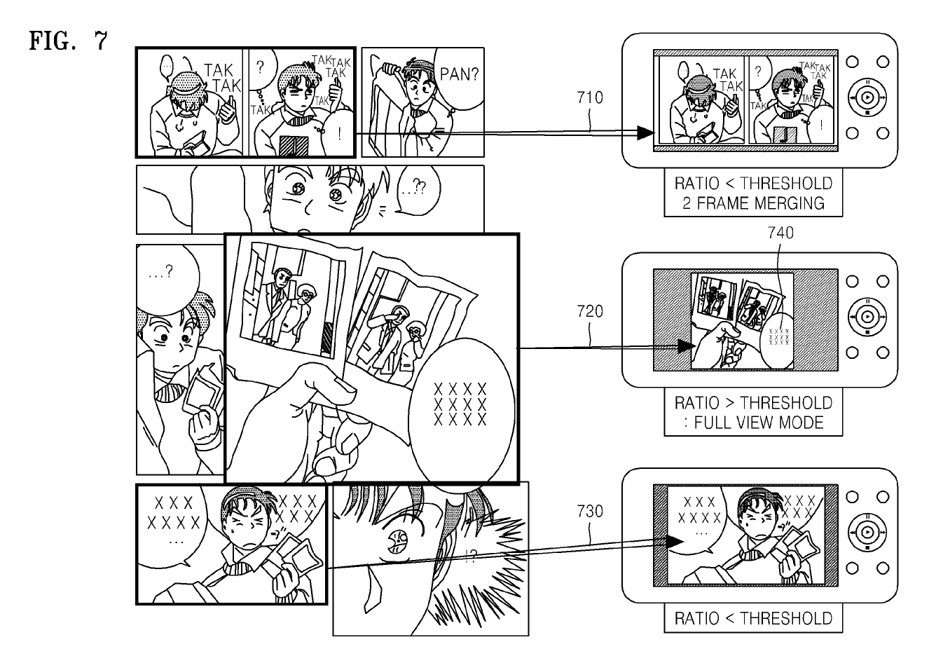

If the ratio is smaller than the threshold, a new frame is generated by merging a current frame and a next frame in operation 630, and a new ratio is extracted again using the new frame. If the new ratio is smaller than the threshold, the new frame is displayed on the display area. Referring to FIG. 7, if the ratio is smaller than the threshold, the two merged frames are displayed on a display area indicated by an arrow 710.

If the ratio is bigger than the threshold, whether the corresponding frame is one frame is determined in operation 640 of FIG. 6. If the corresponding frame is one frame, a view function is converted to a full view mode so as to determine the corresponding frame as the frame to be displayed on a full screen. Referring to FIG. 7, if the ratio is bigger than the threshold, the corresponding frame is displayed in the full view mode on a display area indicated by an arrow 720. In the full view mode, a focusing mark 740 may be set up in a certain area. The user may enlarge a desired area using the focusing mark 740.

However, if the corresponding frame is at least two frames, the current frame is removed and a previous frame is determined as the frame to be displayed. Referring to FIG. 7, if the ratio is smaller than the threshold, the previous frame is displayed on a display area indicated by an arrow 730.

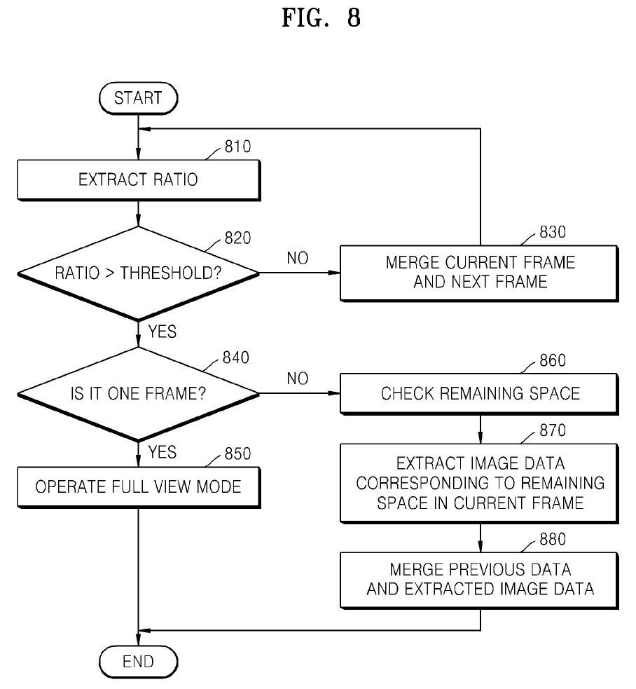

FIG. 8 is a flowchart of a process of adjusting the number of frames to be merged in a display area, according to an embodiment of the present invention. Operations 810, 820, 830, 840, and 850 are similar to operations 610, 620, 630, 640, and 650 of FIG. 6, respectively, and thus detailed descriptions thereof will be omitted.

Operations different from the operations of the process of FIG. 6 will now be described. If the ratio is bigger than the threshold and the corresponding frame is formed of at least two frames, a remaining space in the display area is checked in operation 860. Image data corresponding to the remaining space is extracted from the current frame in operation 870. In operation 880, the previous frame and the extracted image data are merged to be determined as the frame to be displayed.

As described above, according to aspects of the present invention, a comic service can be conveniently provided in a mobile terminal having a small screen. In addition, a comic image can be accurately viewed where distortion due to LCD screen size is minimized. Moreover, a comic image with an indistinct frame can be automatically extracted as a frame unit. Accordingly, aspects of the present invention can be applied to all mobile terminals when viewing comics. Further, a file applying aspects of the present invention can be transmitted to a mobile device. The mobile terminal may be any mobile device, such as a mobile telephone, personal digital assistant (PDA), or personal entertainment device. Further, aspects of the present invention may be applied to any type of content, such as images, movies, or text.

Aspects of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CDs, DVDs, Blu-ray discs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image display controlling method comprising:
generating frames having inner and outer edges based on an image signal;
measuring a ratio of the size of each generated frame to the size of a display area;
adjusting a number of frames to be displayed on the display area according to the measured ratio; and
displaying a frame image corresponding to the adjusted number of frames on the display area.

2. The image display controlling method of claim 1, wherein the generating of frames comprises:
emphasizing edges of the image signal;
binarizing an image of the edge emphasized image signal by comparing each pixel value to a threshold;
detecting data about the outer edge based on data about the binarized image;
detecting a non-linear section of the outer edge by checking linearity of columns and rows of the detected data about the outer edge;
forming a frame of the image signal by interpolating a predetermined linear component to the non-linear section of the outer edge; and
detecting an internal horizontal outline and vertical outline by checking column and row data of an edge of the formed frame.

3. The image display controlling method of claim 2, wherein the forming of the frame comprises interpolating the predetermined linear component from the non-linear section of the outer edge to a linear section of the outer edge.

4. The image display controlling method of claim 2, wherein the detecting of an internal horizontal outline and vertical outline comprises:
determining a row having linear data from a left end to a right end as the internal horizontal outer edge by checking rows of the edge of the formed frame; and
determining a column having linear data from a top end to a bottom end as the internal vertical outer edge by checking columns of the determined internal horizontal outer edge.

5. The image display controlling method of claim 1, wherein the measuring of the ratio comprises measuring the ratio of an outline coordinate of each frame to a size of a fixed display area.

6. The image display controlling method of claim 1, wherein the adjusting of the number of frames to be displayed on the display area comprises:
determining a current frame as the frame to be displayed by converting a mobile terminal to a full view mode if the ratio is bigger than a threshold;
if the ratio is smaller than the threshold, generating a new frame by merging the current frame and a next frame, and measuring the ratio by using the new frame; and
if the ratio measured using the new frame is bigger than the threshold, determining a previous frame as the frame to be displayed, and if the ratio measured by using the new frame is smaller than the threshold, measuring the ratio by merging the current frame and the next frame.

7. The image display controlling method of claim 6, further comprising:
establishing a focusing mark in a predetermined area of a screen of the mobile terminal while converted to the full view mode.

8. The image display controlling method of claim 6, wherein the threshold is obtained by adding a distortion margin and a ratio of the size of a currently used display area to the size of an ideal display area.

9. The image display controlling method of claim 1, wherein the adjusting of the number of frames to be displayed comprises:
checking a remaining space of the display area if the ratio is bigger than the threshold;
extracting data about the remaining space from the previous frame; and
merging the previous frame and the extracted data and determining the merged previous frame and the extracted data as the frame to be displayed.

10. An image display controlling apparatus comprising:
a frame generator to form frames having an outer non-linear section of an outer edge interpolated by a linear component from image data, and to detect internal horizontal/vertical outlines by checking columns and rows of the frames; and
a display area determiner to adjust the number of frames to be displayed on a display area according to a ratio of the size of each frame generated by the frame generator to the size of the display area.

11. The image display controlling apparatus of claim 10, wherein the display area determiner extracts the ratio, and determines the number of frames to be displayed in the display area by comparing the ratio to a predetermined threshold.

12. A mobile terminal comprising:
a storage unit to store image data;
a display to display an image in a frame unit; and
an image signal processor to generate frames having inner and outer edges in regards to the image data stored in the storage unit, to adjust a number of frames to be displayed on a display area according to a ratio of the size of each frame to the size of the display area, and to display the corresponding frames on the display.

13. The mobile terminal of claim 12, wherein the image signal processor comprises:
a resolution improver to emphasize the resolution of an edge of the image data based on an edge detection mask;
a binary image generator to binarize an image signal of the image data having the resolution emphasized by the resolution improver;
a frame generator to form frames having an outer non-linear section of the outer edge interpolated by a linear component of the binarized image signal, and to detect internal horizontal/vertical outlines by checking columns and rows of the frames; and
a display area determiner to adjust the number of frames to be displayed on the display area according to the ratio.

14. The mobile terminal of claim 12, wherein the image data is at least one page of a comic.

15. The mobile terminal of claim 12, wherein the display area determiner compares the ratio with a threshold value, and determines the number of frames to be displayed based on the result of the comparison.

16. The mobile terminal of claim 12, wherein the display area determiner determines the threshold based on a distortion margin and a size of a currently used display area.

17. The mobile terminal of claim 12, wherein, if the ratio is greater than the threshold, the display area determiner determines a current frame as the frame to be displayed.

18. The mobile terminal of claim 12, wherein, if the ratio is less than the threshold, the display area determiner merges two or more frames into a single frame, and the display unit displays the merged frame.

19. A computer readable medium comprising instructions that, when executed by a mobile terminal, cause the mobile terminal to perform a method comprising:
generating a plurality of frames based on an image signal;
determining a ratio of a size of each frame to a size of a display area of the mobile terminal;
automatically adjusting a number of frames to be displayed based on the ratio; and
displaying an image on the display area corresponding the adjusted frames.

20. The computer readable medium of claim 19, wherein, if the ratio is smaller than a threshold, the method further comprises:
determining an amount of available space in the display area; and
merging two or more frames into a merged frame;
wherein the displaying of the image comprises displaying the merged frame.

21. The computer readable medium of claim 20, wherein the adjusting the merging of the two or more frames comprises iteratively merging frames until the ratio of the size of the merged frame is greater than the threshold.
